(19) United States
(12) Patent Application Publication
(10) Pub. No.: US 2009/0091814 A1
(43) Pub. Date: Apr. 9, 2009

(54) STEREO PROJECTION OPTICAL SYSTEM

(75) Inventor: CHIEN-WEN HSU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/952,983

(22) Filed: Dec. 7, 2007

(30) Foreign Application Priority Data
Oct. 5, 2007 (TW) 96137488

(51) Int. Cl. H01S 3/00

(52) U.S. Cl. 359/237

(57) ABSTRACT

A stereo projection optical system, includes a first polarizing beam splitter configured for separating a light input into a first polarized light component and a second polarized light component; a first image assimilator positioned to receive the first polarized light component; a first image assimilator positioned to receive the second polarized light component. The first and second image assimilators respectively generate two images formed by the first polarized light component and the second polarized light component with spatial information. When a viewer wears glasses that have two polarizing lenses whose polarization is perpendicular to each other, the viewer can perceive projected images as being three-dimensional.

### CROSS REFERENCE TO RELATED APPLICATION

This application is related to a co-pending U.S. patent application Ser. No. 11/947086, entitled “STEREO PROJECTION OPTICAL SYSTEM”, which was filed on Nov. 29, 2007 and is assigned to the same assignee as the present application. The disclosure of the above-identified application is incorporated herein by reference.

### RELATED FIELD

The present invention relates generally to projection optical systems, and more specifically to a stereo projection optical system.

### BACKGROUND

Various types of stereoscopic projection optical systems are well known in the art. Such stereoscopic projection optical system typically includes two projectors arranged in parallel so that image from a liquid crystal display (LCD) panel or a slide film is projected on a screen by each light source. As shown in FIG. 4, one of such stereoscopic projectors includes spherical reflective mirrors 1, 1′, lamps 2, 2′, condenser members 3, 3′, LCD panels 4, 4′, and projection lenses 5, 5′.

In a conventional stereoscopic projection optical systems, the stereoscopic picture is obtained by making the polarizing directions of projected beams perpendicular to each other. This is achieved by using two projectors, and then the picture from a right projector is only visible to the right eye of a viewer, and the picture from a left projector is only visible to the left eye of a viewer, respectively.

In the conventional stereoscopic projection optical system, the lamps 2, 2′ are independently operated. When the beams from each of the lamps 2, 2′ pass through the LCD panels 4, 4′ respectively, and the beams are respectively polarized in the direction of a polarizing axis of a polarizing plate attached to the light source side of the corresponding LCD panel 4, 4′. As a result, a half of the beams condensed by each of the condenser members 3, 3′ is absorbed by the polarizing plate before passing through the corresponding LCD panel 4, 4′. The lost light is absorbed as heat by the polarizing plates. This necessitates a separate cooling device to increase the heat-dissipating efficiency at the polarizing plates of the LCD panels 4, 4′.

It is desired to provide a stereo projection optical system which can overcome the above-described deficiencies.

### SUMMARY

In accordance with an exemplary embodiment, a stereo projection optical system includes a first polarizing beam splitter configured for separating a light input into a first polarized light component and a second polarized light component which is substantially orthogonal to the first polarized light component, a first image assimilator positioned to receive the first polarized light component and a second image assimilator positioned to receive the second polarized light component. The first image assimilator comprises a second polarizing beam splitter and a first reflective spatial light modulator. The second polarizing beam splitter is configured for receiving the first polarized light component and reflecting the first polarized light component into the first reflective spatial optical modulator. The first reflective spatial optical modulator is configured for converting the first polarized light component into the second polarized light component and emitting the second polarized light component via the second polarizing beam splitter. The second image assimilator comprises a third polarizing beam splitter and a second reflective spatial light modulator. The third polarizing beam splitter is configured for receiving the second polarized light component and transmitting the second polarized light component into the second reflective spatial optical modulator. The second reflective spatial optical modulator is configured for converting the second polarized light component into the first second polarized light component and emitting the first polarized light component via the third, second polarizing beam splitter in turn.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of preferred and exemplary embodiments thereof and with reference to the accompanying drawings, in which:

FIG. 1 illustrates a configuration of a stereo projection optical system in accordance with a first embodiment of the present invention;

FIG. 2 is similar to FIG. 1, but further illustrates a plurality of analyzers disposed in the stereo projection optical system;

FIG. 3 illustrates a configuration of a stereo projection optical system in accordance with a second embodiment of the present invention; and

FIG. 4 illustrates a configuration of a conventional stereoscopic projection optical system.

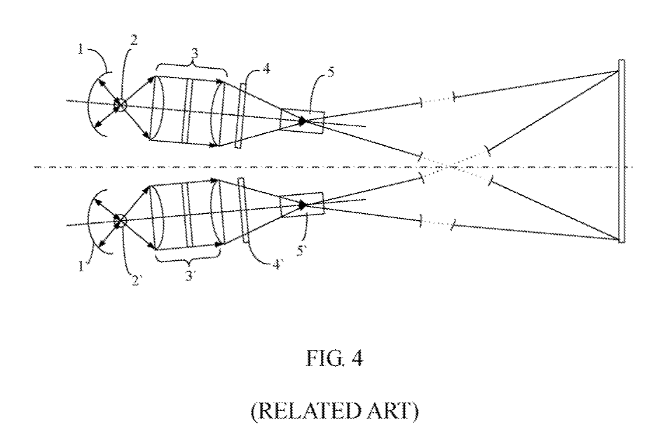

### DETAILED DESCRIPTION OF THE PREFERRED EMBODIMENTS

A detailed explanation of a stereo projection optical system according to each of various embodiments of the present invention will now be made with reference to the drawings attached hereto.

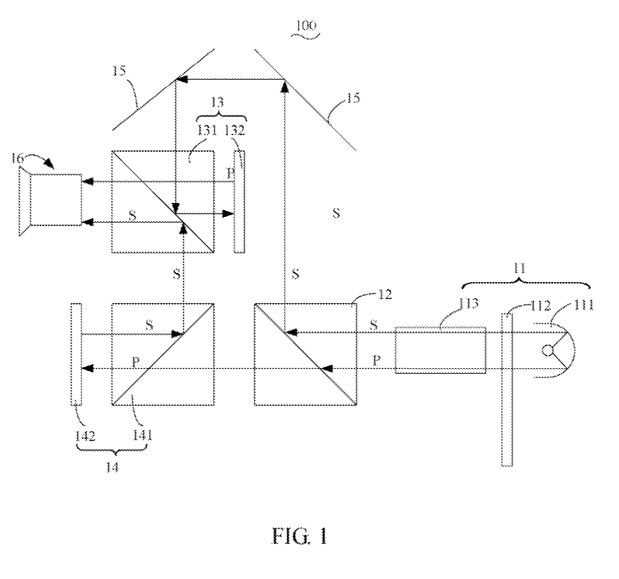

Referring to FIG. 1, a stereo projection optical system 100 according to a first embodiment in the present invention is shown. The stereo projection optical system 100 includes a light source assembly 11, a first polarizing beam splitter (PBS) 12, a first image assimilator 13 having a second PBS 131, a second image assimilator 14 having a third PBS 141, two reflective apparatuses 15, and a projecting lens 16.

The light source assembly 11 includes a light source 111, a color wheel 112 positioned to receive light from the light source 111, and a integrator 113 positioned to receive the light emerging from the color wheel 112. The light source 111 can be a halogen lamp, a metal halogen lamp, a light emitting diode (LED), and the like. In the present embodiment, the light source 111 is a halogen lamp that emits white light. The color wheel 112 is configured for splitting the emergent light from the light source 111 into time-sequenced red, green and blue light beams. The color wheel 112 includes red, green and blue color filters, and the center of the color wheel 112 is connected to a motor (not shown) such that the color wheel 112 is rotated. The integrator 113 is configured for processing the light beam emitted from the color wheel 112 such that light beams exiting the integrator 113 have a uniform spatial distribution.

The first PBS 12 is positioned to receive light output form the light source assembly 11, and is configured for separating the non-polarized light beam emitted from the light source assembly 11 into a first polarized light component and a second polarized light component which is substantially orthogonal to the first polarized light component. The first polarized light component can be S-polarized light or P-polarized light. When the first polarized light component is S-polarized light, the second polarized light component is P-polarized light. In the present embodiment, the first polarized light component is S-polarized light, and the second polarized light component is P-polarized light. The first polarized light component is reflected by the first PBS 12 to one of the reflective apparatus 15, and the second polarized light component is transmitted directly through the first PBS 12. The first PBS 12 can be a wire grid polarizer (WGP) or a polarizing beam splitter prism. In the present embodiment, the first PBS 12 is a polarizing beam splitter prism.

The first, second image assimilators 13, 14 are respectively disposed in the light paths of the first, second polarized light component. Configurations and work principles of the first and second image assimilators 13, 14 are substantially same. Thus for convenience, the first image assimilator 13 is presented only as an example to explain the configurations and work principles of the first and second image assimilators 13, 14.

The first image assimilator 13 includes a first spatial light modulator (SLM) 132 and the second PBS 131. Configurations and work principles of the second PBS 131 is substantially same as those of the first PBS 12. The second PBS 131 is configured for receiving the first polarized light component and reflecting it. The first SLM 132 is reflective type SLM, and can be a liquid crystal on silicon (LCoS) panel. The first SLM 132 is configured for modifying the polarization of the first polarized light component in a predetermined manner and superimposing spatial information on the first polarized light component, such that the first polarized light component is converted to a second polarized light component. The first SLM 132 emits the second polarized light component to the second PBS 131, and the second polarized light component passes directly through the second PBS 131.

The second image assimilator 14 also includes a second SLM 142, which is substantially same in principle as the first SLM 141 of the first image assimilator 13. The second image assimilator 14 is disposed in the light path of the second polarized light component emitted from the first PBS 12. The second polarized light component passes directly through the third PBS 141 and reaches the second SLM 142. The second SLM 142 converts the second polarized light component to the first polarized light component, and superimposes spatial information on it. The second SLM 142 emits the first polarized light component to the third PBS 141, and the first polarized light component is reflected by the third PBS 141 to the second PBS 131 to be reflected to the projecting lens 16.

The two reflective apparatuses 15 can be mirrors and are configured for transmitting/reflecting the first polarized light component emitted from the first PBS 12 to the first image assimilator 13.

The projecting lens 16 is positioned to receive the light outputs of the first image assimilators 13 and is configured for magnifying the light outputs and projecting an image on a screen (not shown).

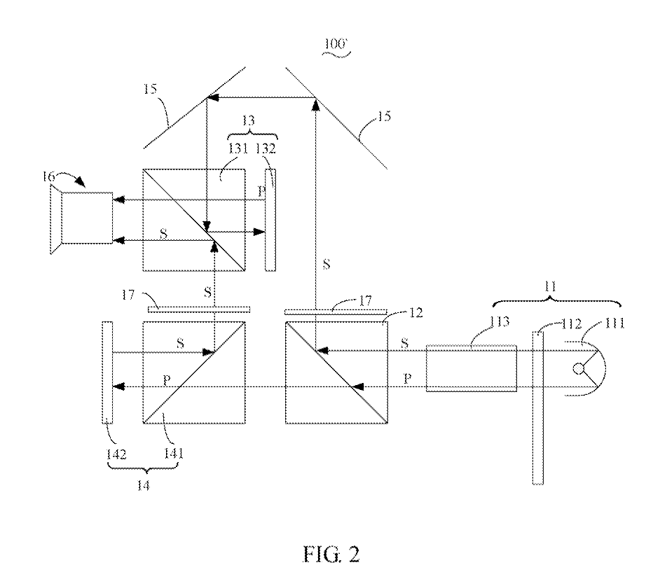

It should be understood that the stereo projection optical system 100 can also include a plurality of analyzers 17 in order to promote contrast of images projected by the stereo projection optical system 100. Referring to FIG. 2, this shows twp analyzers 17 incorporated in a stereo projection optical system 100′. Each analyzers 17 can be a polarizer, which is configured for transmitting light of a predetermined polarization and removing light of other polarization. In alternative embodiment, the analyzers 17 can have other desired light processing characteristics. In the present embodiment, the analyzers 17 transmit P-polarized light and remove S-polarized light. The analyzers 17 are disposed between the first PBS 12 and the first image assimilators 13, and between the first image assimilator 13 and the second image assimilator 14.

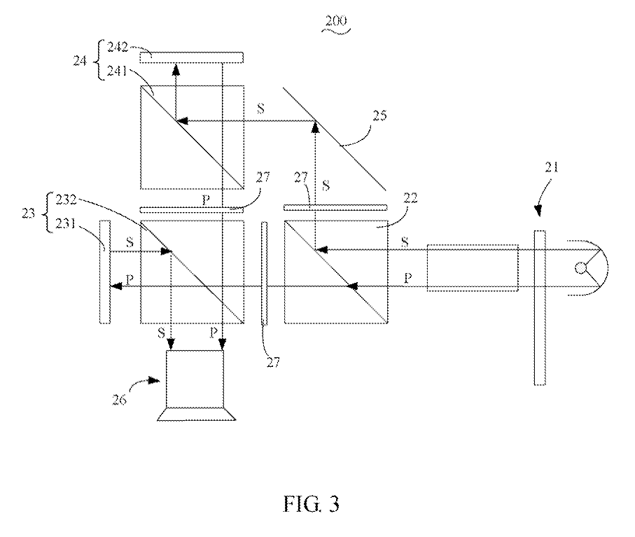

Referring to FIG. 3, a stereo projection optical system 200 according to a second embodiment in the present invention is shown. The stereo projection optical system 200 includes a light source assembly 21, a first PBS 22, a first, second image assimilators 23, 24 respectively having a second PBS 231 and a third PBS 241, a reflective apparatus 25 and a projecting lens 26.

Similar to the first embodiment, the first image assimilator 23 includes a first SLM 232, and the second image assimilator 24 includes a first SLM 242. The difference between the first embodiment and the second embodiment is that the stereo projection optical system 200 includes a reflective apparatus 25 and the projecting lens 26 is disposed to receive light output of the first image assimilator 23. The reflective apparatus 25 is disposed between the first PBS 22 and the first image assimilator 23 and configured for reflecting the first polarized light component from the first PBS 22 to the first image assimilator 23. Other optical elements and light path in the stereo projection optical system 200 are substantially the same as in the first embodiment.

The stereo projection optical system 200 includes a plurality of analyzers 27 in order to promote the contrast of the images projected by the stereo projection optical system 200. The locations of the analyzers 27 are substantially the same to those of the first embodiment. It should be understood that in alternative embodiments, any one, more or all of the analyzers 17 could be omitted.

In each of the above-described stereo projection optical system 100, 100′ and 200, the first and second image assimilators respectively generate two images formed by the first polarized light component and the second polarized light component with spatial information. When a viewer wears glasses that have two polarizing lenses whose polarization is perpendicular to each other, the viewer can perceive projected images as being three-dimensional. As described above, each PBS splits an incident beam into two beams, and the two SLMs obtain image beams and generate corresponding images beams having spatial information. All the image beams having spatial information are simultaneously projected on the screen as a 3-D image. The efficiency of light utilization is high, with little loss of light compared to conventional system.

It should be understood that the above-described embodiment are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A stereo projection optical system, comprising:
a first polarizing beam splitter configured for separating a light input into a first polarized light component and a second polarized light component which is substantially orthogonal to the first polarized light component;
a first image assimilator positioned to receive the first polarized light component and comprising a second polarizing beam splitter and a first reflective spatial light modulator, the second polarizing beam splitter configured for receiving the first polarized light component and reflecting the first polarized light component into the first reflective spatial light modulator, the first reflective spatial light modulator configured for converting the first polarized light component into the second polarized light component and emitting the second polarized light component into the second polarizing beam splitter, the second polarizing beam splitter further configured for allowing the second polarized light component to transmit directly therethrough; and
a second image assimilator positioned to receive the second polarized light component and comprising a third polarizing beam splitter and a second reflective spatial light modulator, the third polarizing beam splitter configured for receiving the second polarized light component and allowing the second polarized light component to transmit into the second reflective spatial light modulator, the second reflective spatial optical modulator configured for converting the second polarized light component into the first second polarized light component and emitting the first polarized light component into the second, third polarizing beam splitter.

2. The stereo projection optical system as claimed in claim 1, wherein the first, second and third polarizing beam splitters are wire grid polarizers.

3. The stereo projection optical system as claimed in claim 1, wherein the first, second and third polarizing beam splitters are polarizing beam splitter prisms.

4. The stereo projection optical system as claimed in claim 1, wherein each of the first and second reflective spatial light modulators is a liquid crystal on silicon.

5. The stereo projection optical system as claimed in claim 1, wherein the first polarized light component is one of S-polarized light and P-polarized light, and the second polarized light component is the other of S-polarized light and P-polarized light.

6. The stereo projection optical system as claimed in claim 1, further comprising a projecting lens positioned to receive the light output from the first image assimilator and configured for projecting an image.

7. The stereo projection optical system as claimed in claim 1, further comprising a plurality of analyzers respectively disposed between the first polarizing beam splitter and the first, second image assimilators.

8. The stereo projection optical system as claimed in claim 1, further comprising an analyzer respectively disposed between the first image assimilator and second image assimilator.

9. The stereo projecting optical system as claimed in claim 1, further comprising at least a reflective apparatus disposed between the first polarizing beam splitter and the first image assimilator and configured for reflecting the light output from the first polarizing beam splitter to the first image assimilator.
